(19) United States
(12) Patent Application Publication
(10) Pub. No.: US 2023/0182392 A1
(43) Pub. Date: Jun. 15, 2023

(54) SCOOP AND DISPENSE FOR ADDITIVE MANUFACTURING

(71) Applicant: HEWLETT-PACKARD DEVELOPMENT COMPANY, L.P., Spring, TX (US)

(72) Inventors: Michael Gabriel Monroe, Corvallis, OR (US); Macia Sole Pons, Corvallis, OR (US); Kevin Edward Swier, Corvallis, OR (US)

(21) Appl. No.: 17/926,087

(22) PCT Filed: Oct. 24, 2020
(86) PCT No.: PCT/US2020/057173

§ 371 Date: Nov. 17, 2022

(51) Int. Cl. B29C 64/321; B29C 64/214; B29C 64/393; B33Y 30/00; B33Y 40/00

(52) U.S. Cl. CPC B29C 64/321; B29C 64/214; B29C 64/393; B33Y 30/00; B33Y 40/00; B29C 64/153

(57) ABSTRACT

In one example, a device for dispensing build material powder in an additive manufacturing machine includes a first dispenser including a first scoop rotatable in a first direction to scoop build material powder into the first dispenser, a second dispenser including a second scoop rotatable in a second direction opposite the first direction to scoop build material powder into the second dispenser, and a leveler between the first dispenser and the second dispenser.

### BACKGROUND

Additive manufacturing machines, sometimes called 3D printers, produce objects by building up layers of material. Digital data is processed into slices each defining that part of a layer of build material to be formed into the object. In some additive manufacturing machines, the object slices are formed in a powdered build material spread in layers over the build area. Particles in each of the successive layers of powder are melted, sintered, bound or otherwise fused to form a solid object. Manufacturing proceeds layer by layer and slice by slice until the object is complete.

### DRAWINGS

FIGS. 1-3 illustrate an example system for dispensing and leveling build material powder in an additive manufacturing machine.

FIGS. 4-6 illustrate an example scoop and dispense device for dispensing and leveling build material powder in an additive manufacturing machine.

FIGS. 7-19 illustrate an example scoop and dispense device for dispensing and leveling build material powder in an additive manufacturing machine. FIGS. 7-14 show a sequence of operation for the scoop and dispense device. FIGS. 15-19 show the scoop and dispense device in more detail.

FIGS. 20-23 show a sequence of operation for an example scoop and dispense device dispensing and leveling build material powder in an additive manufacturing machine.

FIG. 24 is a flow diagram illustrating an example scoop and dispense method for an additive manufacturing machine.

FIG. 25 is a block diagram illustrating an example system for dispensing and leveling build material powder in an additive manufacturing machine.

FIG. 26 is a block diagram illustrating an example controller for the system of FIG. 25.

The figures are not necessarily to scale. The same part numbers designate the same or similar parts throughout the figures.

### DESCRIPTION

In some additive manufacturing machines, build material powder is supplied along each end of the build area. A new “scoop and dispense” technique has been developed to dispense powder from each such supply in a layer over the build area and then level the layer. In one example, build material powder is scooped from one supply, dispensed in a layer over the build area, and leveled to even the layer. Then, for a next layer, powder is scooped from the opposite supply, dispensed in a next layer over the build area, and leveled to even the next layer.

“Scoop and dispense” may be implemented, for example, with a device that includes two scoop dispensers and a leveler between the dispensers such that the leveler always trails one of the dispensers over the build area. Each dispenser has a rotatable scoop to scoop build material powder into the corresponding dispenser from the respective supply at each end of the build area. One dispenser scoops and dispenses while the device moves left to right over the build area with the trailing leveler leveling the powder in an even layer. The other dispenser scoops and dispenses while the device moves right to left over the build area with the trailing leveler leveling the powder in an even next layer.

These and other examples described herein and shown in the figures illustrate but do not limit the scope of the patent, which is defined in the Claims following this Description.

As used in this document: “build area” means any suitable structural area to support build material for fusing (e.g., melting, sintering, or binding), including a platform, underlying layers of both fused and unfused build material on a platform, and in-process slice and other object structures; a “computer readable medium” is any non-transitory tangible medium that can embody, contain, store, or maintain instructions for use by a processor and may include, for example, circuits, integrated circuits, ASICs (application specific integrated circuits), hard drives, random access memory (RAM), read-only memory (ROM), and memory cards and sticks and other portable storage devices; “rotate” means to turn about an axis; and “translate” means to move along a line.

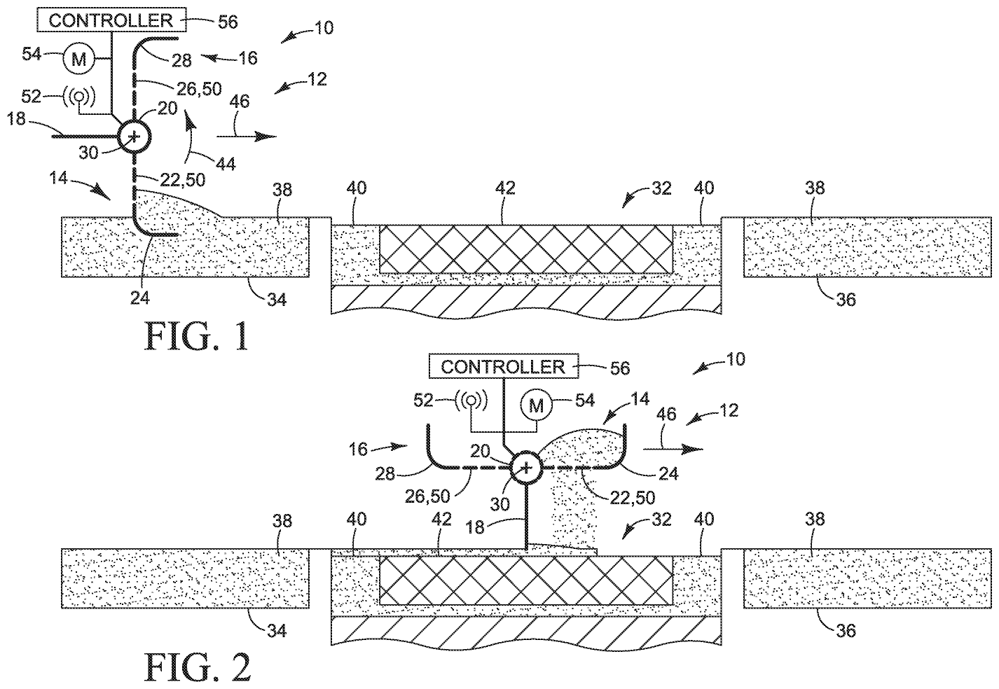

FIGS. 1-3 illustrate an example system 10 for dispensing and leveling build material powder in an additive manufacturing machine. Referring to FIGS. 1-3, system 10 includes a scoop and dispense device 12 with a first dispenser 14, a second dispenser 16, and a leveler 18. Dispensers 14, 16 and leveler 18 are operatively connected to a shaft 20. In this example, dispensers 14, 16 are connected to shaft 20 diametrically opposed to one another (i.e., 180° apart). Leveler 18 is connected to shaft 20 between dispensers 14, 16, 90° from each dispenser. First dispenser 14 includes a first dispensing part 22 and a first scoop 24. Second dispenser 16 includes a second dispensing part 26 and a second scoop 28. Each scoop 24, 28 is positioned outboard from the corresponding dispensing part 22, 26.

Dispensers 14, 16 rotate with shaft 20 about an axis of rotation 30. Dispensers 14, 16 translate with shaft 20 back and forth over a build area 32 and over first and second supplies 34, 36 of build material powder 38. Powder supplies 34, 36 are positioned along opposite ends of build area 32. Any suitable carriage and drive mechanism (not shown in FIGS. 1-3) may be used to move device 12 back and forth over build area 32 and powder supplies 34, 36. In the example shown, build area 32 is formed by an area 40 of unfused build material and an area 42 of fused build material.

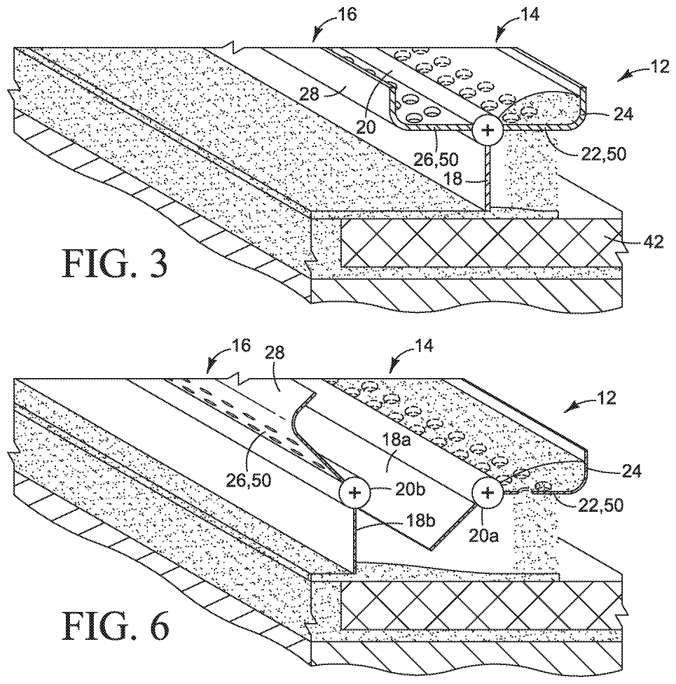

As shown in FIG. 1, first scoop 24 scoops powder 38 from first supply 34 into first dispensing part 22 as first scoop 24 rotates in a first direction, counter-clockwise in FIG. 1. Scoop 24 may be rotated and translated simultaneously to scoop powder 38 from supply 34, as indicated by rotation arrow 44 and translation arrow 46. As shown in FIGS. 2 and 3, first dispensing part 22 dispenses powder 38 on to build area 32 and leveler 18 levels the powder as first dispenser 14 translates over build area 32 in a first direction, to the right in FIGS. 2 and 3 as indicated by translation arrow 46. In this example, dispensing part 22 includes a screen 50. Powder 38 falls through perforations in screen 50 on to build area 32. Also in this example, system 10 includes a vibrator 52 operatively connected to screen 50 (through shaft 20 in this example). Vibrating screen 50 increases the rate powder 38 is dispensed on to build area 32. The size, shape, and density of perforations in screen 50 and the magnitude and frequency of vibrations may be varied to achieve the desired dispense rate.

After the prior layer of build material is processed, for example by fusing some of the powder into an object slice, the operation is reversed to scoop and dispense powder 38 from second supply 36 for the next layer. Second scoop 28 scoops powder 38 into second dispensing part 26, second dispensing part 26 dispenses powder on to build area 32, and leveler 18 levels the powder as second dispenser 16 translates to the left back over build area 32.

In the example shown in FIGS. 1 and 2, scoop and dispense system 10 includes a motor 54 and a controller 56 operatively connected to motor 56 and vibrator 52. Controller 56 includes the programming, processing and associated memory resources, and the other electronic circuitry and components to control the operative components of system 10, and may include distinct control elements for individual system components. Motor 54 is operatively connected to shaft 20 to rotate shaft 20, and thus dispensers 14, 16, at the direction of controller 56.

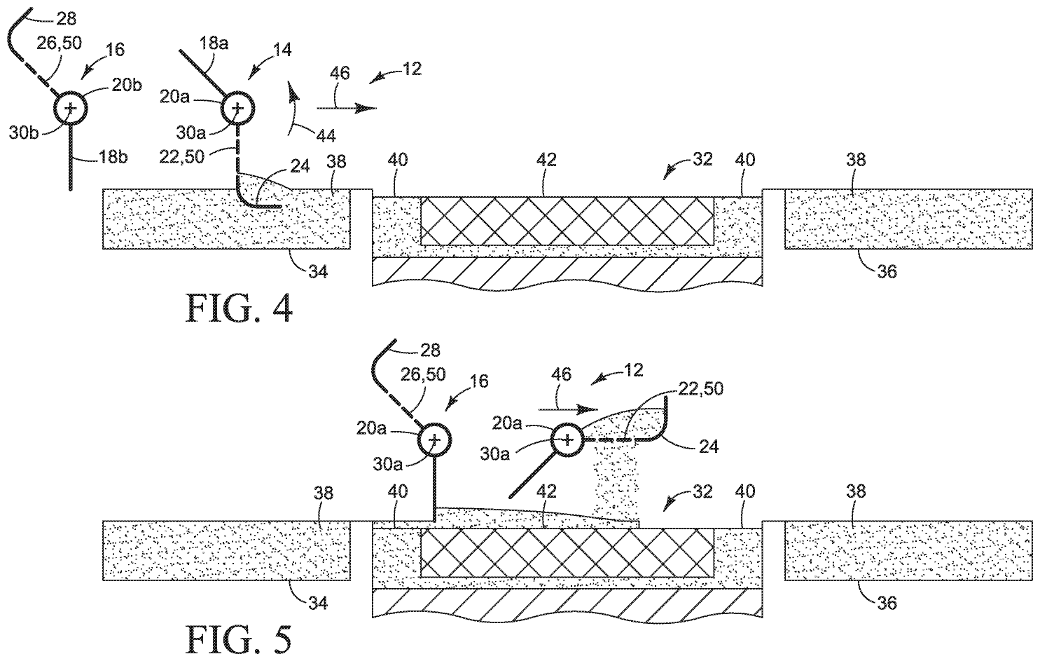

FIGS. 4-6 illustrate another example scoop and dispense device 12 for a scoop and dispense system such as a system 10 with a controller 56 shown in FIGS. 1 and 2. In the example shown in FIGS. 4-6, each dispenser 14, 16 includes a distinct leveler 18a, 18b and shafts 20a, 20b. Referring to FIGS. 4-6, first dispenser 14 is operatively connected to a first shaft 20a along with a first leveler 18a and second dispenser 16 is operatively connected to a second shaft 20b along with a second leveler 18b. Dispenser 14 rotates with shaft 20a about an axis of rotation 30a. Dispenser 16 rotates with shaft 20b about an axis of rotation 30b. Shafts 20a, 20b and thus dispensers 14, 16 and levelers 18a, 18b translate together, for example on a single carriage. Shafts 20a, 20b rotate independently of one another so that first dispenser 14 and first leveler 18a rotate independently of second dispenser 16 and second leveler 18b.

As shown in FIG. 4, first scoop 24 scoops powder 38 into first dispensing part 22 as first shaft 20a and thus first dispenser 14 is rotated counter-clockwise and translated to the right. Second shaft 20b and thus second dispenser 16 translate to the right together with first dispenser 14 but remain rotationally stationary. As shown in FIGS. 5 and 6, first dispensing part 22 dispenses powder and second leveler 18b levels the powder as dispensers 14 and 16 are translated together to the right over build area 32. Both dispensers 14, 16 remain rotationally stationary while translating over build area 32. The operation is reversed to scoop and dispense powder 38 from second supply 36. Second scoop 28 scoops powder 38 into second dispensing part 26 and second dispensing part 26 dispenses powder on to build area 32 as second dispenser 16 is translated to the left back over build area 32 with first leveler 18b leveling the powder.

In this example, dispensers 14, 16 and levelers 18a, 18b are oriented with respect to one another on shafts 20a, 20b so that leveler 18b levels powder 38 as the dispensers move left to right over build area 32 and leveler 18a levels powder 38 as the dispensers move right to left over build area 32. For example, as shown in FIGS. 4-6, first dispenser 14 and second leveler 18a are aligned with one another, second dispenser 16 and first leveler 18b are aligned with one another, and each dispenser 14, 16 and corresponding leveler 18a, 18b are spaced apart 135° (measured clockwise from the dispenser) on shafts 20a, 20b, respectively.

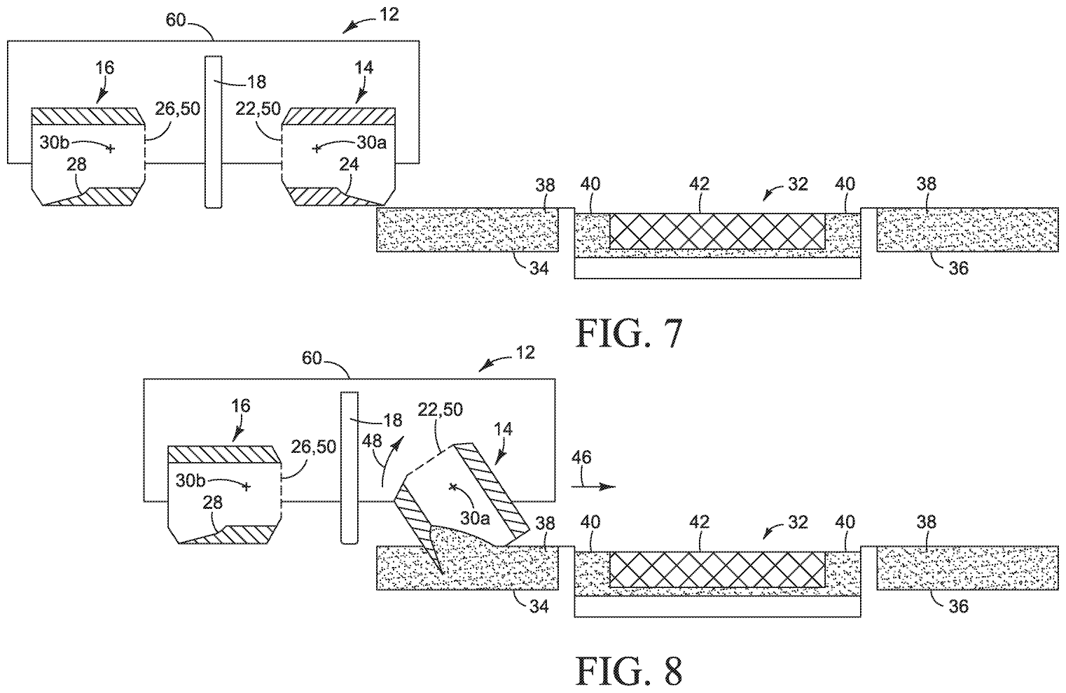

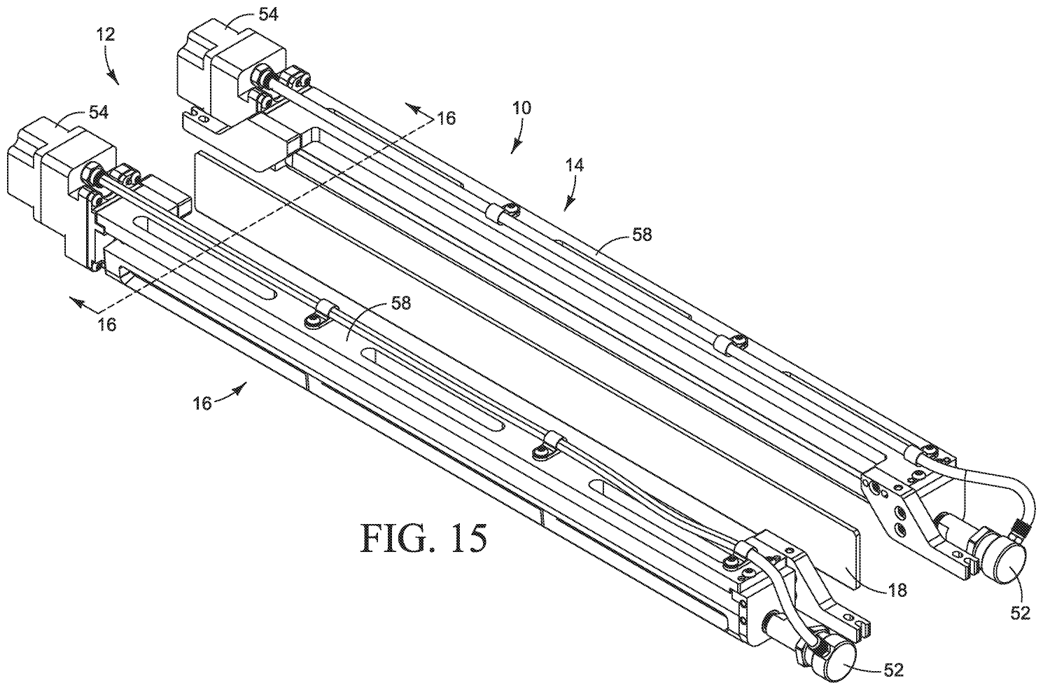

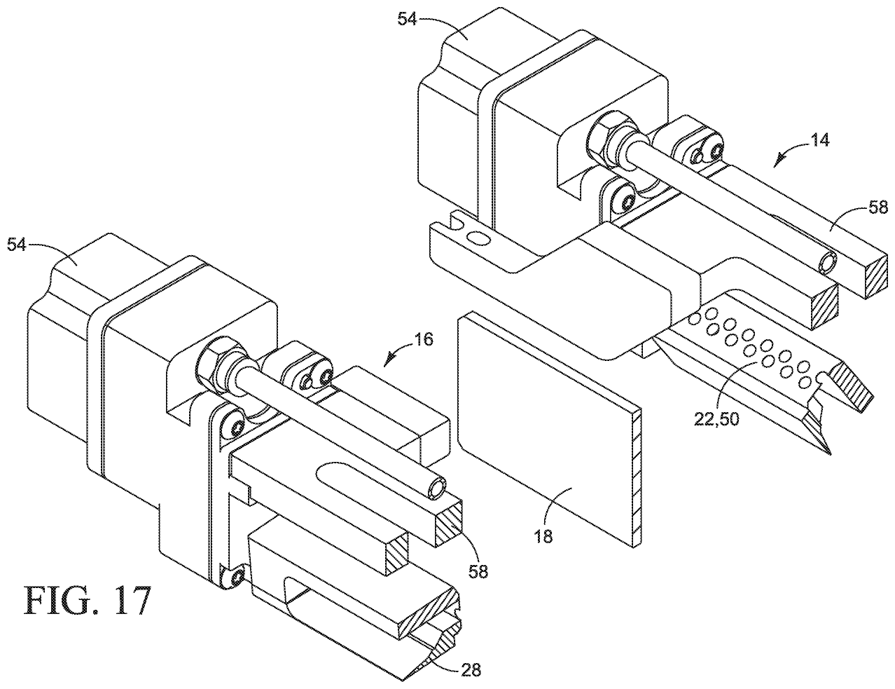

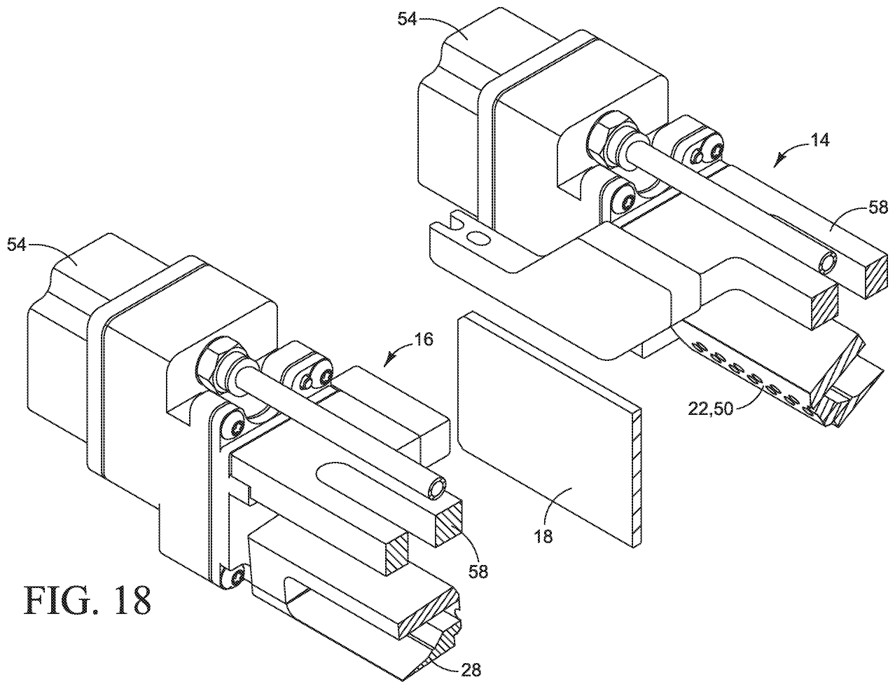

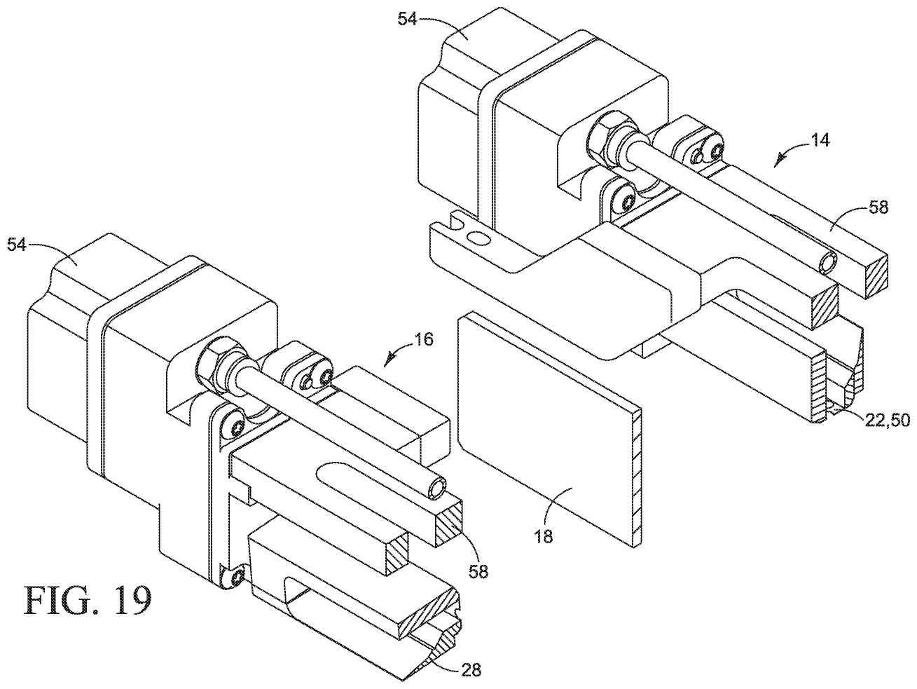

FIGS. 7-19 illustrate an example scoop and dispense device 12 with a first dispenser 14, a second dispenser 16, and a leveler 18. FIGS. 7-14 show a sequence of operation for device 12. FIGS. 15-19 show dispensers 14, 16 in more detail.

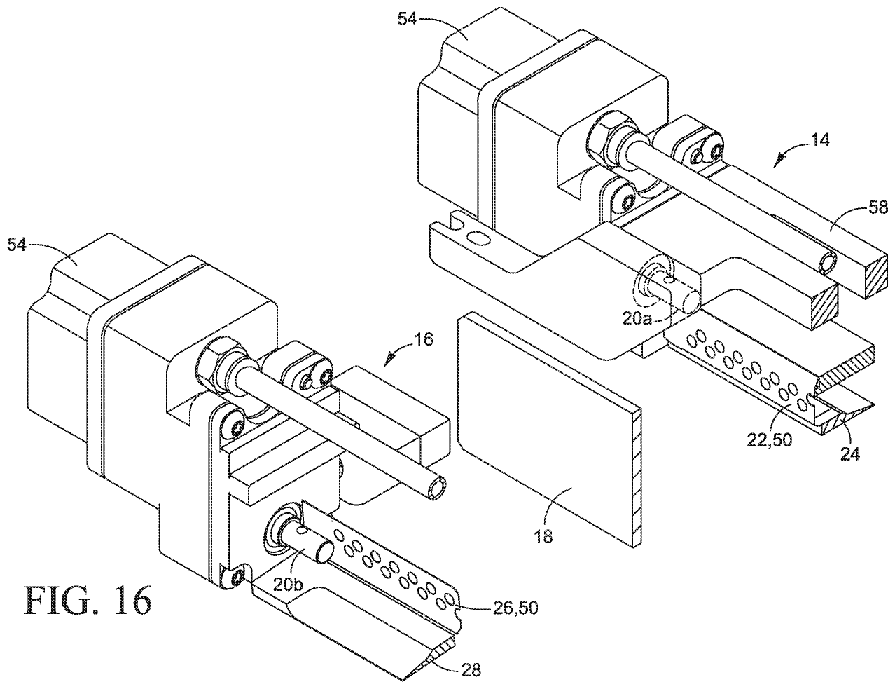

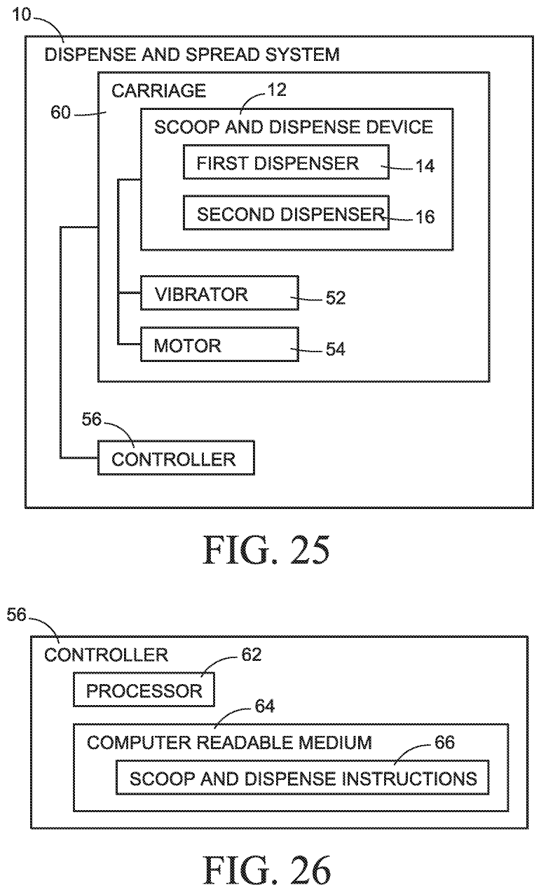

Referring first to FIGS. 15 and 16, dispensers 14 and 16 are operatively connected to shafts 20a and 20b. Shafts 20a and 20b are shown in FIG. 16. Part of second dispenser 16 is omitted in FIG. 16 to expose shaft 20b. Shaft 20a is hidden behind dispenser 14 in FIG. 16 and thus shown in dashed lines. In this example, each dispenser 14, 16 is attached to a shaft 20a, 20b, respectively, at one end and to a cantilever 58 at the other end. Leveler 18 is rotationally stationary in this example. A bucket shaped first dispenser 14 includes a first dispensing part 22 and a first scoop 24. A bucket shaped second dispenser 16 includes a second dispensing part 26 and a second scoop 28. In this example, each dispensing part 22, 26 includes a screen 50. Also in this example, system 10 includes a vibrator 52 operatively connected to each screen 50. A motor 54 is operatively connected to each shaft 20a, 20b to rotate the shafts, and thus dispensers 14, 16, for example at the direction of a controller 56 shown in FIG. 25.

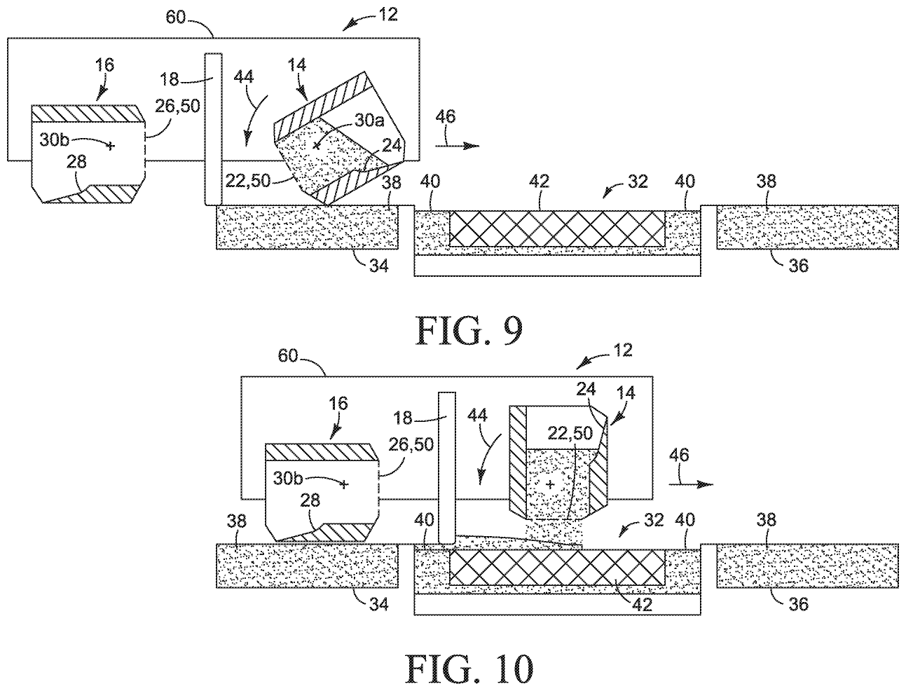

FIGS. 7-14 show a sequence of operation for device 12 dispensing and leveling powdered build material over a build area 32 in an additive manufacturing machine. In FIG. 7, a carriage 60 carrying dispensers 14, 16 and leveler 18 is parked next to first powder supply 34 at one end of build area 32. In FIG. 8, carriage 60 with dispensers 14, 16 translates to the right as first dispenser 14 rotates clockwise about a first axis of rotation 30a so that scoop 26 moves into powder supply 34 to begin scooping powder 38, as indicated by arrows 46 and 48. In FIG. 9, the direction of rotation is reversed to counter-clockwise as first dispenser 14 continues translating to scoop powder 38 into first dispensing part 24 and on to screen 50. In FIG. 10, first dispenser 14 has stopped rotating in an upright orientation and powder is dispensed through screen 50 and leveled by leveler 18 trailing first dispenser 14. The position of dispensers 14, 16 in FIGS. 16-19 correspond to the position shown in FIGS. 7-10, respectively.

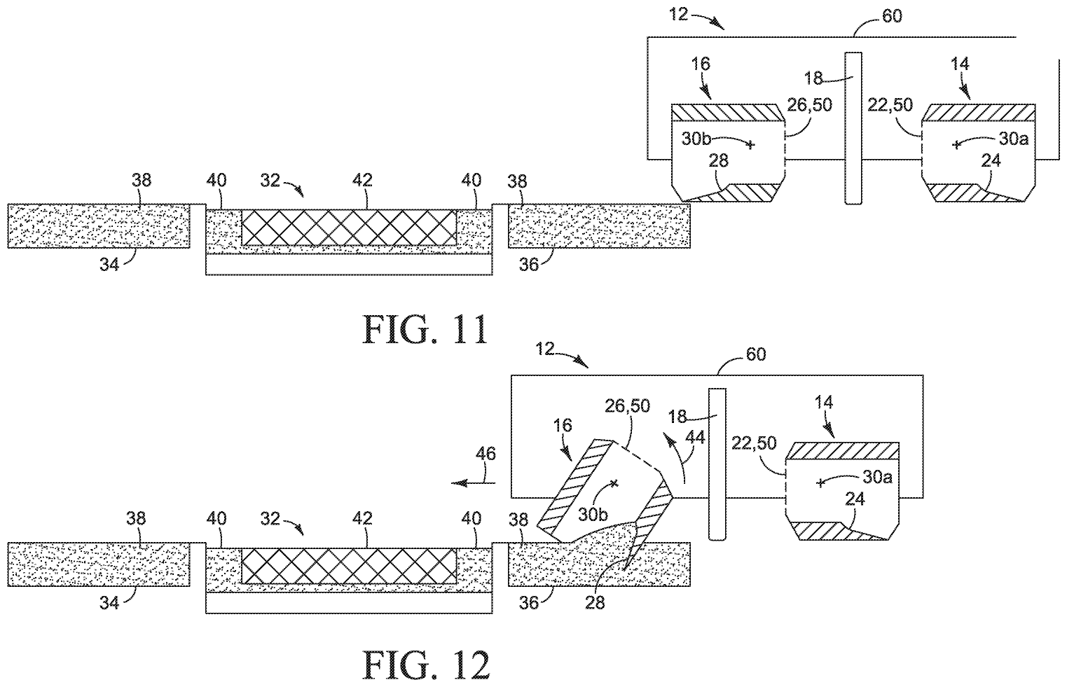

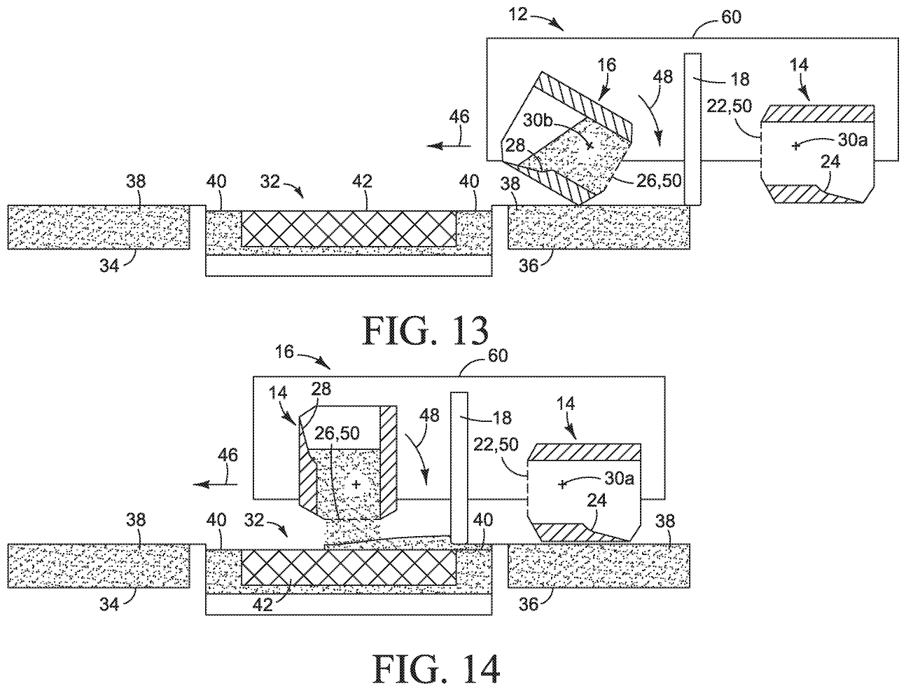

In FIG. 11, carriage 60 with dispensers 14, 16 and leveler 18 is parked next to second powder supply 36 at the other end of build area 32 in preparation for dispensing and leveling the next layer. In FIG. 12, carriage 60 with dispensers 14, 16 translates to the left as second dispenser 16 rotates counter-clockwise so that second scoop 28 moves into second powder supply 36 to begin scooping powder 38. In FIG. 13, the direction of rotation is reversed to clockwise as second dispenser 16 continues translating to scoop powder 38 into second dispensing part 26 and onto screen 50. In FIG. 14, second dispenser 16 has stopped rotating in an upright orientation and powder is dispensed through screen 50 and leveled by leveler 18 trailing second dispenser 16.

Depending on the size, shape, and density of the perforations in a screen 50, some powder 38 may flow out of each dispenser 14, 16 at the urging of gravity alone. Dispensing may be started (or the rate of gravity flow increased) at a desired location by turning on vibrator 52. Dispensing may be stopped (or the rate of gravity flow decreased) at a desired location by turning off vibrator 52. Screen 50 may be mechanically isolated from scoop 24, 28, if desired, so that vibrator 52 vibrates screen 50 and not scoop 24, 28. Leveler 18 may push any excess powder into the downstream supply 34, 36 at the end of each pass. While it is expected that leveler 18 usually will be implemented as a blade, as shown in the figures, other suitable configurations for a leveler 18 in a scoop and dispense device 12 are possible.

In one example, the volume of powder scooped into each dispenser 14, 16 at the corresponding supply 34, 36 is approximately equal to the volume of powder in a single layer. The angle of attack and depth of each scoop 24, 28 into powder supply 34, 36, as well as the duration of the scooping operation, may be set to scoop the desired volume of powder 38, so that each dispenser 14, 16 dispenses approximately a single layer of powder over build area 32 to reduce the volume of powder in front of leveler 18 and thus reduce the unwanted effects of pushing powder over build area 32.

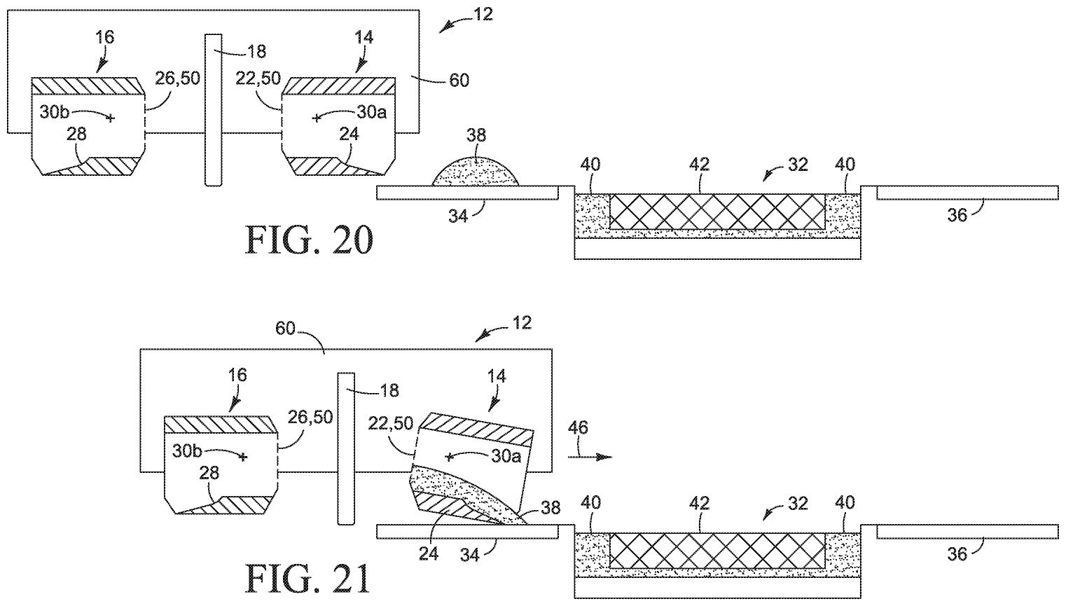

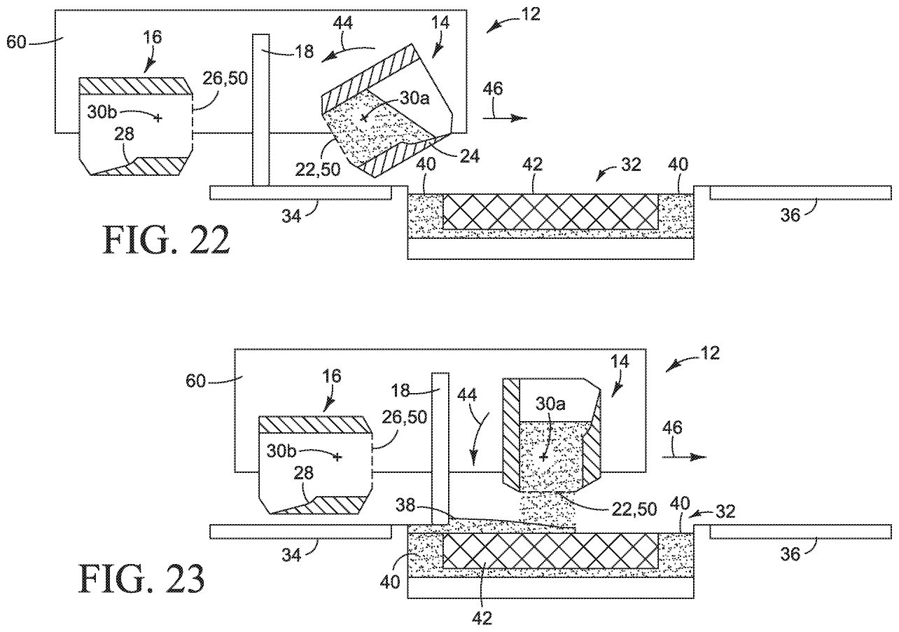

FIGS. 20-23 show a sequence of operation for an example scoop and dispense device 12 dispensing and leveling powdered build material over a build area 32 in an additive manufacturing machine. In FIG. 20, a carriage 60 carrying a first dispenser 14, a second dispenser 16, and a leveler 18 is parked next to a first powder supply 34 at one end of build area 32. In this example, powder supply 34 includes a pile of build material powder 38. In FIG. 21, dispenser 14 has rotated down (clockwise) until the leading edge of scoop 24 contacts the surface of supply 34. As carriage 60 translates to the right, scoop 24 scoops the pile of powder 38 into dispenser 14. In FIG. 22, first dispenser 14 is rotated counter-clockwise as it continues translating to move the powder into first dispensing part 24 and on to screen 50. In FIG. 23, first dispenser 14 has stopped rotating in an upright orientation and powder is dispensed through screen 50 and leveled by leveler 18 trailing first dispenser 14. After the prior layer of build material is processed, for example by fusing some of the powder into an object slice, the operation is reversed to scoop and dispense powder with second dispenser 16 from a second supply 36 for the next layer.

In one example, the volume of powder in the pile presented to a dispenser 14, 16 at each supply 34, 36 is approximately equal to the volume of powder in a single layer. Accordingly, each dispenser 14, 16 scoops and dispenses approximately only a single layer of powder over build area 32, to reduce the volume of powder in front of leveler 18 and thus reduce the unwanted effects of pushing powder across build area 32.

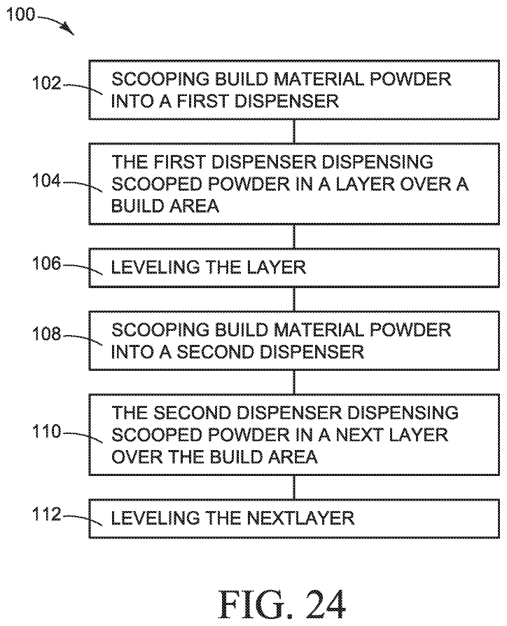

FIG. 24 is a flow diagram illustrating an example method 100 for an additive manufacturing machine. Method 100 may be implemented, for example, by a controller executing scoop and dispense instructions described below with reference to FIGS. 25 and 26. Referring to FIG. 24, method 100 includes scooping build material powder into a first dispenser (block 102), for example as shown in FIGS. 8 and 9, the first dispenser dispensing scooped powder in a layer over a build area (block 104), for example as shown in FIG. 10, and leveling the layer (block 106), for example as shown in FIG. 10. Method 100 also includes scooping build material powder into a second dispenser (block 108), for example as shown in FIGS. 12 and 13, the second dispenser dispensing scooped powder in a next layer over the build area (block 110), for example as shown in FIG. 14, and leveling the next layer (block 112), for example as shown in FIG. 14.

FIG. 25 is a block diagram illustrating an example system 10 for dispensing and leveling build material powder in an additive manufacturing machine. Referring to FIG. 25, system 10 includes a carriage 60 carrying a scoop and dispense device 12, a vibrator 52, a motor 54, and a controller 56. Any suitable carriage and drive mechanism may be used for carriage 60 in FIG. 25 to move device 12 back and forth over the powder supplies and build area as described above. Scoop and dispense device 12 in FIG. 25 may be implemented, for example, with a device 12 shown in FIGS. 1-23.

Vibrator 52 is operatively connected to dispensers 14, 16 to vibrate a screen or other dispensing part to facilitate dispensing powder on to the build area. Vibrator 52 in FIG. 25 represents a single vibrator for examples in which both dispensers 14, 16 share a common axis of rotation, such as the example shown in FIGS. 1-3. Vibrator 52 in FIG. 25 represents multiple vibrators for examples in which dispensers 14, 16 turn on separate axes, such as the examples shown in FIGS. 4-23.

Motor 54 is operatively connected to dispensers 14, 16 to rotate the dispensers at the direction of controller 56. Motor 54 in FIG. 25 represents a single motor for examples in which both dispensers 14, 16 share a common axis of rotation, such as the example shown in FIGS. 1-3. Motor 54 in FIG. 21 represents multiple motors for examples in which dispensers 14, 16 turn on separate axes, such as the examples shown in FIGS. 4-23.

Controller 56 includes the programming, processing and associated memory resources, and the other electronic circuitry and components to control the operative components of system 10, and may include distinct control elements for individual system components. In an example shown in FIG. 26, controller 56 includes a processor 62, and a computer readable medium 64 in communication with processor 62. Scoop and dispense instructions 66 residing on computer readable medium 64 represent programming that when executed by processor 62 cause a scoop and dispense device, such as a device 12 shown in FIGS. 1-23, to perform scoop and dispense operations, such as a method 100 in FIG. 24.

The examples shown in the figures and described above illustrate but do not limit the patent, which is defined in the following Claims.

“A”, “an”, and “the” as used in the Claims means one or more unless “only one” thing is recited. For example, “a leveler” means one or more levelers and subsequent reference to “the leveler” means the one or more levelers.

1. A device for dispensing build material powder on to a build area in an additive manufacturing machine, the device comprising:
a first dispenser translatable back and forth over the build area, the first dispenser including:
a first dispensing part configured to dispense powder on to the build area as the first dispenser is translated over the build area in a first direction; and
a first scoop configured to scoop powder into the first dispensing part as the first scoop is rotated in a first direction;
a second dispenser translatable with the first dispenser back and forth over the build area, the second dispenser including:
a second dispensing part configured to dispense powder on to the build area as the second dispenser is translated over the build area in a second direction opposite the first direction; and
a second scoop configured to scoop powder into the second dispensing part as the second scoop is rotated in a second direction; and
a leveler translatable with the first dispenser and the second dispenser back and forth over the build area and configured to level powder dispensed by each dispenser, the leveler located with respect to the first dispenser and the second dispenser such that the leveler trails the first dispenser in the first direction and the leveler trails the second dispenser in the second direction.

2. The device of claim 1, comprising a carriage operatively connected to the dispensers and the leveler to carry the dispensers and the leveler together back and forth over the build area.

3. The device of claim 1, wherein each dispensing part and corresponding scoop are integrated into a single unit.

4. The device of claim 1, wherein each dispensing part comprises a screen.

5. The device of claim 1, wherein:
the first scoop is rotatable on a first axis;
the second scoop is rotatable on a second axis; and
the leveler comprises a first leveler rotatable with the first scoop and a second leveler rotatable with the second scoop.

6. The device of claim 1, wherein:
the first scoop and the second scoop are rotatable together on the same axis; and
the leveler is a single leveler rotatable together with the first scoop and the second scoop.

7. A system for dispensing build material powder in an additive manufacturing machine, comprising:
a first dispenser including a first scoop rotatable in a first direction to scoop build material powder into the first dispenser;
a second dispenser including a second scoop rotatable in a second direction opposite the first direction to scoop build material powder into the second dispenser;
a leveler between the first dispenser and the second dispenser; and
a controller operatively connected to the first and second dispensers, the controller having a processor and a computer readable medium with instructions thereon that, when executed by the processor, cause:
the first scoop to scoop build material powder into the first dispenser;
the first dispenser to dispense scooped powder in a layer over a build area;
the leveler to level the layer; and then
the second scoop to scoop build material powder into the second dispenser;
the second dispenser to dispense scooped powder in a next layer over the build area; and
the leveler to level the next layer.

8. The system of claim 7, comprising a vibrator operatively connected to the first and second dispensers and wherein:
the instructions that cause the first dispenser to dispense scooped powder in a layer over a build area include instructions that cause the vibrator to vibrate the first dispenser; and
the instructions that cause the second dispenser to dispense scooped powder in a next layer over the build area include instructions that cause the vibrator to vibrate the second dispenser.

9. The system of claim 7, wherein:
the instructions that cause the first scoop to scoop build material powder into the first dispenser include instructions to simultaneously translate and rotate the first scoop through a first supply of build material powder; and
the instructions that cause the second scoop to scoop build material powder into the second dispenser include instructions to simultaneously translate and rotate the second scoop through a second supply of build material powder.

10. A device for dispensing build material powder in an additive manufacturing machine, comprising:
a first dispenser including a first scoop rotatable in a first direction to scoop build material powder into the first dispenser;
a second dispenser including a second scoop rotatable in a second direction opposite the first direction to scoop build material powder into the second dispenser; and
a leveler between the first dispenser and the second dispenser.

11. The device of claim 10, wherein the first scoop is rotatable on a first axis and the second scoop is rotatable on a second axis.

12. The device of claim 10, wherein the first scoop and the second scoop are rotatable together on the same axis.

13. The device of claim 11, wherein in the leveler comprises a first leveler rotatable with the first scoop and a second leveler rotatable with the second scoop.

14. The device of claim 12, wherein the leveler is only one leveler rotatable together with the first scoop and the second scoop.

15. The device of claim 10, wherein the leveler is only one leveler that does not rotate.
